(19) United States
(12) Patent Application Publication
(10) Pub. No.: US 2011/0282869 A1
(43) Pub. Date: Nov. 17, 2011

(54) Access to information by quantitative analysis of enterprise web access traffic

(76) Inventors: Maxim Zhilyaev, Palo Alto, CA (US); Dmitry Leshchiner, Belmont, MA (US)

(21) Appl. No.: 13/091,725

(22) Filed: Apr. 21, 2011

Related U.S. Application Data
(60) Provisional application No. 61/333,260, filed on May 11, 2010.

(51) Int. Cl. G06F 17/30; G06F 7/00

(52) U.S. Cl. 707/723; 707/748; 707/E17.107

(57) ABSTRACT

A method for improving search quality by quantitative analysis of enterprise web access traffic is disclosed. This invention relates to the field of data processing systems and more particularly to the field of knowledge management in corporate or enterprise. Performing search on heterogeneous data in an enterprise is complex and challenging. Present day technologies deploy costly and time consuming methods involving manual operation of data integration, pre-processing, mining and interpretation tools. Further, these methods are inefficient in retrieving relevant data. The proposed method discloses a method for exhaustive monitoring and analysis of intranet traffic to identify and retrieve relevant data in enterprise search. Resource relevance is revealed by traffic analyzer based on empirical, content-independent metric. Further, analysis of intranet traffic provides effective, timely and personalized information resource to user for selective information discovery, cross-linking of disjoint data repositories, one-click navigation to popular applications, index trimming and the like.

This application claims the benefit of U.S. patent application No. 61/333,260, filed May 11, 2010.

### TECHNICAL FIELD

This invention relates to the field of data processing systems and more particularly to the field of knowledge management.

### BACKGROUND

Nowadays, large amount of technical information or knowledge is available within an enterprise. The information in an enterprise may be stored at a wide variety of sources, e.g. databases, proprietary help system, online manuals and so on. An enterprise may have various departments and each department may have huge amount of data stored in their respective database. Information may be available in other departments but relevant data stored at different database of different departments may not be properly linked. Generally, different kinds of data types are stored in the same database which constitutes heterogeneous format database. Further, same data may be copied and stored across various database leading to duplication of data. Furthermore, users requirements keep changing frequently, therefore lots of the stored data may get outdated soon. Information may also be available from sources such as World Wide Web. Information keeps growing and users perform search for information within and/or outside the enterprise which makes enterprise search complex and challenging.

In an enterprise, new teams are formed for specific project and after completion of the project, teams are dissolved and later, again new teams are formed based on new projects. Further, new employees join the enterprise while some leave. These factors lead to rapid change in employee's information and profile. Further, the enterprise information exchange may happen in meetings or discussions where most of the information may not be recorded and stored in any database. The information may just remain with participants of the meeting or discussion, and folklore can become the information avenue. Information requests are commonly resolved by talking to a colleague or by posting a question to a mailing list.

When a particular search is performed by a user, inadequate or irrelevant data results are delivered due to an over-polluted database. Further, relevant resources are not searchable as the data scattered in departmental repositories are not indexed. At present various strategies are deployed to address these problems like advanced content analytics (semantic analysis, categorization, human tagging), various personalization techniques, query expansion, bookmarks analysis, UI enrichment, among others. These strategies involve manual operation of a number of data integration, pre-processing, mining and interpretation tools. While each of the strategies make marginal contributions; however none of them are adequate enough to perform search efficiently. Further, these strategies are expensive and time consuming to the point that it is often not feasible for many enterprises. A user spends large amount of time in discovering and remembering the location of information and retrieving it. Current technology forces users to learn and remember variety of metaphors, UI and specific search techniques for a particular task. The existing techniques are not intuitive to a user and lack cohesion. The advent of Internet based data sources, including data from World Wide Web has exacerbated this problem.

Due to the aforementioned reasons enterprise search is not effective in present day systems.

### SUMMARY

Accordingly the invention provides a technique for designing of improved search quality by quantitative analysis of enterprise web access traffic.

A method for enhancing access to information in an enterprise is disclosed. The method comprising analyzing plurality of users data traffic patterns to improve personalized resource ranking for the users.

A system for enhancing access to information in an enterprise is disclosed. The system comprising a data traffic analyzer that is configured for analyzing plurality of users data traffic patterns to improve personalized resource ranking for the users.

A data traffic analyzer for enhancing access to information in an enterprise is disclosed. The traffic analyzer configured for analyzing plurality of users data traffic patterns to improve personalized resource ranking for the users.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various Figures. The embodiments herein will be better understood from the following description with reference to the drawings, in which:

FIG. 1 is a flow diagram depicting the process of analyzing traffic in an enterprise, according to embodiments as disclosed herein;

FIG. 2 depicts network devices being used to collect web access statistics, according to embodiments as disclosed herein;

FIG. 3 depicts traffic analyzer interfacing search solution modulation, according to embodiments as disclosed herein;

FIG. 4 depicts traffic analyzer being used to improve customer-facing search, according to embodiments as disclosed herein;

FIG. 5 is a flow diagram depicting the process of page ranking based on an employee's web access history, according to embodiments as disclosed herein;

FIG. 6 is a flow diagram depicting the process of page ranking based on web access history of employees with similar job profile, according to embodiments as disclosed herein;

FIG. 7 is a flow diagram depicting the process of page ranking based on age of information, according to embodiments as disclosed herein;

FIG. 8 is a flow diagram depicting the process of index trimming, according to embodiments as disclosed herein;

FIG. 9 is a flow diagram depicting the process of selective indexing based on employee's web access history, according to embodiments as disclosed herein;

FIG. 10 is a flow diagram depicting the process of cross-linking data between disjoint corporate tools, according to embodiments as disclosed herein;

FIG. 11 is a flow diagram depicting the process of context sensitive search, according to embodiments as disclosed herein,

FIG. 12 is a flow diagram depicting the process of personalized intranet navigation, according to embodiments as disclosed herein;

FIG. 13 depicts traffic analyzer in Smart Intranet navigation, according to embodiments as disclosed herein;

FIG. 14 depicts traffic analyzer being used to improve Internet site local search, according to embodiments as disclosed herein; and

FIG. 15 depicts traffic analyzer being used for cross-site Internet searching, according to embodiments as disclosed herein.

### DETAILED DESCRIPTION OF THE FIGURES

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

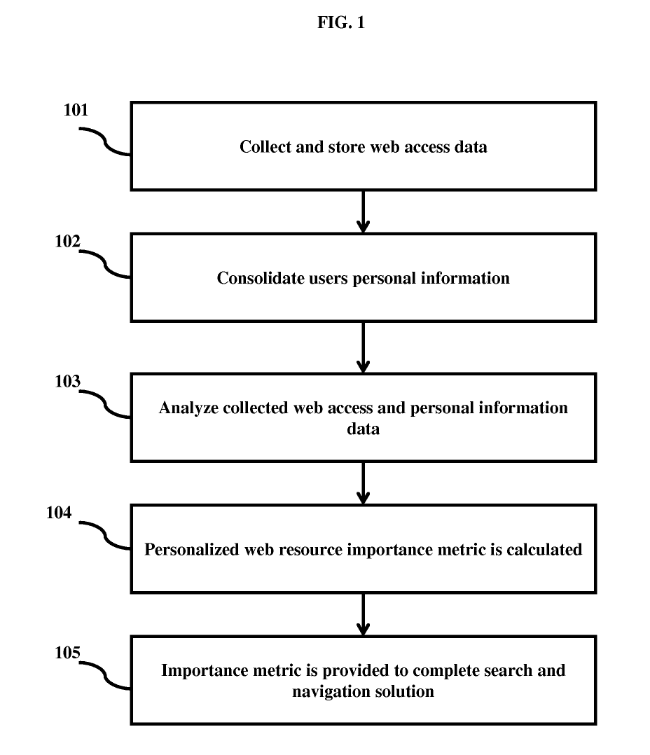

The embodiments herein achieve a technique for designing of improved search quality by quantitative analysis of enterprise web access traffic by providing systems and methods thereof. Referring now to the drawings, and more particularly to FIGS. 1 through 15, where similar reference characters denote corresponding features consistently throughout the Figures, there are shown preferred embodiments.

The empirical user-value of an information resource manifests in the frequency and recentness of its access by a user himself and/or his close colleagues. This manifestation may not be quantified by traditional indexing or personalization methods since employees' information access may bear no relation to their search activity. However, if the whole enterprise is considered as one web site with a limited audience, it is possible to monitor and analyze corporate web traffic in its entirety. This analysis uncovers the web access patterns of the corporate work force and provides critical ranking information to the enterprise search solution. Without this information, even the smartest search engine will either miss a sought page or bury it under a pile of semantically groomed but still irrelevant data.

The methodology disclosed below is often described in terms of (and with the applications to) the corporate environment. In which environment employees are the users of the corporate content and the corporate search and navigation services. However, a skillful practitioner will be able to apply the same method to the situation when the web audience is located outside the corporate boundaries: for example, in the case of a customer-facing content services or just common Internet browsing and searching.

The pattern of information resources usage across enterprise reveals how employees utilize corporate tools and information repositories. The analysis of such access patterns enables navigational shortcuts, makes possible cross-linking of disjoint data repositories, and helps to further narrow down a scope of the corporate search. Further, exhaustive monitoring and analysis of enterprise traffic indicate information demand and reveals its importance. Enterprise traffic analysis provides an empirical, content-independent metric of how relevant information is to the user's request.

FIG. 1 is a flow diagram depicting the process of analyzing traffic in an enterprise, according to embodiments as disclosed herein. Web access data like assess time, resource URL, Internet address and/or credentials, other useful information for subsequent analysis are collected and stored (101) in a Traffic Analysis Data Repository. Any suitable method may be used to collect useful web access data information from observed web traffic. This information may comprise of an employee identity, credentials, web session identifiers, URLs of the accessed web resources, content of requested pages, date/time of the request being issued, etc. Collected web access data is aggregated in the Traffic Analysis Data Repository. Further, user's personal information like reporting structure, department membership, mailing list subscriptions, meetings co-participation, email headers, etc are consolidated (102) in the Traffic Analysis Data Repository along with web access statistics. Collected web access data and personal information data are analyzed (103) and personalized web resource importance metrics are calculated (104) and provided (105) to various parts of a complete search and navigation solution. In an embodiment, importance metric may include frequency of access of information by user, recency of access, context of information and relationships between users. For example, providing an importance metric of search results personalized for an employee issuing a search, augment the above importance metric with an employee immediate page visit history, enable corporate crawler to skip pages of lower importance, enable corporate search engine to identify importance partner site resources, enable corporate indexer to prune non-important documents off the index, enable cross-linkage of otherwise isolated enterprise web tools, dynamically suggest navigational short-cuts based on individual, as well as collaborative, web usage history and the like. The various actions in method 100 may be performed in the order presented, in a different order or simultaneously. Further, in some embodiments, some actions listed in FIG. 1 may be omitted.

The entire corporate network may be monitored and web traffic data may be extracted and stored. Similarly, there are numerous ways to implement collecting and storing web access data like web access logs from corporate web servers may be collected and their content may be analyzed, independent agents (e.g. software agents) which intercept web traffic may be installed on employees desktop/laptop computers or installing web traffic monitoring agents on enterprise web server computers to extract web access data and/or web traffic may be collected from Internet by participating sites recording access traffic and submitting aggregated information to a centrally located repository.

Further, user personal and collaborative data can be retrieved from multiple sources in numerous ways. Personal information may be downloaded from corporate sources or corporate directory may provide details such as employee job role, reporting structure, department membership and geographical location. Further, corporate mailing lists subscriptions and mail server can provide information about an employee working, interests groups and correspondents with whom employee actively communicates, respectively. Corporate meeting scheduling service can provide information on working groups an employee actively participates in. It is also possible to monitor corporate network to extract similar information. For example, monitoring email traffic can provide mutual correspondence relationship between employees as well as mailing list membership, and mutual presence on CC-lists. A skillful art practitioner will identify many ways and sources to extract employee personal information from either the corporate content or corporate network traffic using bug database, support calls info, code check-in history, etc.

When an audience is located outside the corporate intranet (e.g. corporate customer-facing or just plain Internet content), personal information could be collected in a numerous way. Personal information can be collected by identifying IP address, using available demographic information and/or using collaborative filtering technique. Further, using Cookie setting techniques, whereby multiple sites set the cookie in the user browser and report that cookie information to a central repository. This process makes possible to identify multiple site visitors, which in turn enables personalization based on sites content. Furthermore, users' profiles could be provided by partners or participating sites without violating privacy. Personal information is aggregated in the Traffic Analysis Data Repository along with Web Access statistics.

Web access data and personal information data collected need to be analyzed. While performing analysis, it is necessary to quantify the strength of relationship between users. One method of such quantification may be based on an observation that users belonging to the same groups within an enterprise are likely to look for similar content. Furthermore, it's arguable that mutual membership in a small group indicates closer relationship then mutual membership in a large group. Therefore, a possible relationship measure between two users could be a sum of their common groups' size inverses. For example, suppose that Bob and Melissa both belong to three corporate groups i.e. G₁, G₂ and G₃. Whereby, G₁ is a department where they both work together, G₂ is a mailing list which both of them have subscribed to, and G₃ is a meeting which both of them attend. Then strength of their relationship hereinafter referred as R is:

R=1/|G₁|+1/|G₂|+1/|G₃|,

where |G₁| is the size of group Gᵢ.

Further, if two users belong to N common groups: G₁, G₂, G₃, G_{N} then their relationship measure can be defined by the formula below:

R=Σᵢ₌₁^{N}1/|Gᵢ|

Another measure of relationship between users could be how often they communicate (for example, send mails) with each other and/or appear together as recipients from same correspondence (for example CC-header of email messages). Using email example, suppose there are N emails that are CC'd to both Bob and Melissa, and it is known when those emails were sent. Then, the following relationship measure between Bob and Melissa can be defined:

R=Σᵢ₌₁^{N}1/AGEᵢ,

is the age of the i-th email, meaning time difference between now and when email was sent.

Similar measures (or combination of them) as listed above employing various normalization, standardization and weighting techniques can be used to define strength of employee's relationship. Furthermore, a multitude of other measures may be based on available sources of the user data, for example one may use an employee's position in the reporting structure, his (or hers) professional grade, etc. Furthermore, similar techniques could be implemented to estimate relationship between Internet users, where the common groups could be geographical locations and demographic features, while to measure togetherness/relationship, common pages viewed and/or same product ordered, etc can be considered.

The empirical importance of a web resource is expressed by its access frequency (how often it is accessed) and its access recentness (how recently it was accessed). One can quantify such expression by direct counting of resource accesses normalized by their access age. Whereby, an age of an access is simply the time elapsed between now and when the access occurred. If a resource was access N times in the past, and the age of each access is known, then the resource importance (hereinafter referred as I) can be computed as:

I=Σᵢ₌₁^{N}1/AGEᵢ,

here AGEᵢ—is the age of the i-th access

This metric provides overall “importance” of a resource to the whole enterprise. Incorporate the strength of relationship between users in the metric computed above can personalize importance metric. Conceivably, a resource is more important to a user if its being accessed frequently and recently by either himself and/or his strongly related users (for example, immediate colleagues). Let us consider an example where M users access a given resource and each user is assigned a number between 1 to M. A strength of relationship between i-th and j-th user is defined as Rᵢⱼ and a k-th user access score to that resource is defined as Sₖ and is given as:

Sₖ=Σᵢ₌₁^{N}1/AGEᵢ,

here N—is the number of accesses made by k-th user, and AGEᵢ—is the age of each access.

A measure of personalized importance of a resource to u-th user (Iᵤ) is defined as:

Iᵤ=Σₖ₌₁^{M}Rᵤₖ·Sₖ

Therefore, it could be said that the personalized importance of a resource to a particular user is the total sum of accesses to that resource, where each access is divided by an access age and multiplied by strength of “relationship” between the user in question and the actual resource visitor. This measure gives preferential treatment to pages accessed by a user himself and/or other visitors closely related to him (e.g. co-workers) and pages accessed mostly frequently and recently.

A trivial importance measure of a resource to a group of users may be implemented, by adding individual values of Iu for each employee in the group. The same procedure can be applied to assess the importance of a set of resources to a user or users. A person skillful in the art will recognize how to deploy the described methodology to incorporate web access data and users personal information to develop similar (or similar in spirit) methods to quantify and rank web resource(s) with respect to a particular user(s).

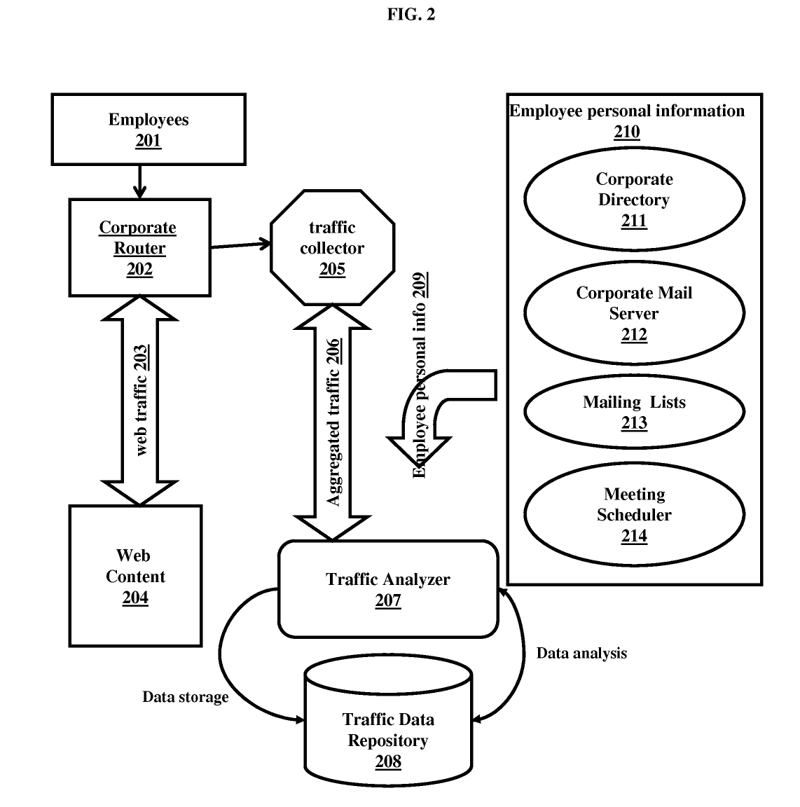

FIG. 2 depicts network devices being used to collect web access statistics, according to embodiments as disclosed herein. It discloses that employees 201 access the corporate network through a corporate router 202 for information. A corporate router 202 forwards data across corporate networks. Routers 202 perform the data “web traffic directing” functions on the Internet/intranet. The corporate router(s) are connected to network device(s) such as Traffic Collector 205 and it exchanges web traffic 203 with web content 204. Traffic collector 205 passively monitors and aggregates web traffic 206 found on the corporate network. Traffic Collector 205 submits aggregated traffic 206 data (who accessed which information resource, and when) to a centrally located Traffic Analyzer 207 which is another network device. Information from multiple Traffic Collectors 205 is aggregated by traffic analyzer 207 into a Traffic Analysis Data Repository 208 for subsequent time/frequency analysis of how employees use web resources. Further, Traffic Analyzer 207 incorporates employee's personal and collaborative information 209 like reporting structure, scheduling data, mailing lists assignments, mutual email communication, etc from corporate directory 211, corporate mail server 212, mailing lists 213, meeting scheduler 214, etc to provide personalized page-ranking based on users corporate memberships and collaboration evidences. Traffic Analyzer 207 computes personalized importance metric for every resource in the repository 208 with respect to a particular employee, a corporate group, or the whole enterprise.

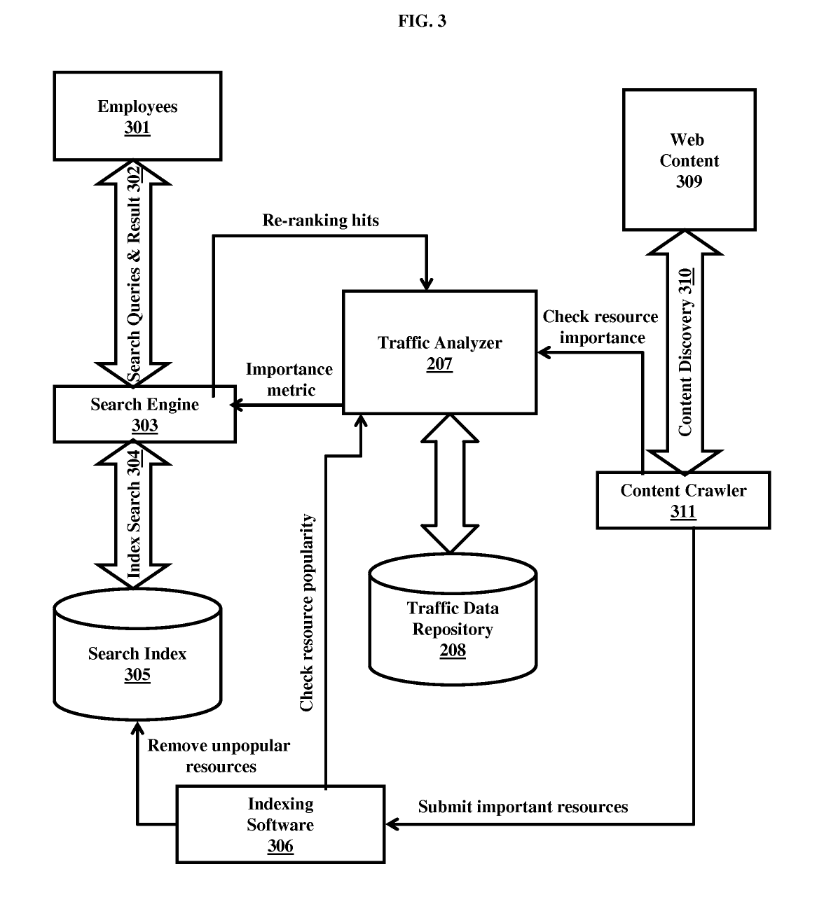

FIG. 3 depicts traffic analyzer interfacing search solution modulation, according to embodiments as disclosed herein. It discloses how Traffic Analyzer integrates with already existing corporate search solutions (search engines, indexers, and crawlers). Employees 201 interact with a search engine 303 in order to perform search and retrieve result for corresponding search. The search engine 303 requests for personalized importance metric from Traffic Analyzer 207 to re-rank search results. Further, the search engine 303 is connected to search index 305 to perform index search and retrieve corresponding result. A crawler 311 is connected to web content 309 to discover content of the information and crawler 311 consults Traffic Analyzer 207 to identify which pages in the departmental wild are important enough to be included in the corporate search repository 208. Indexing software 306 consults Traffic Analyzer 207 to identify rarely or never accessed resources and removes them from the search-able index 305.

Another embodiment could deploy web access log collectors, software and hardware agents, and other methods to collect and aggregate web access statistics, and submit these statistics to Traffic Analyzer 207. Further, the Traffic Analyzer 207 may be implemented as a clustered instance of a software program. In yet another embodiments, Traffic Collector 205 and Traffic Analyzer 207 may occupy the same computational resource and be packaged as a single unit. It is also possible to package other parts of the enterprise search solution, such as a search engine 303, a crawler 311, an indexer 305 and a Traffic Analyzer 207 on same physical or virtual computer instance.

The above embodiments implement Traffic Analyzer to assist with the internal enterprise search. However, corporations often provide search capability for their partners and customers, in which case it is still advantageous to track down external web access statistics to improve customer-facing search quality, even though searchers personal information may be limited.

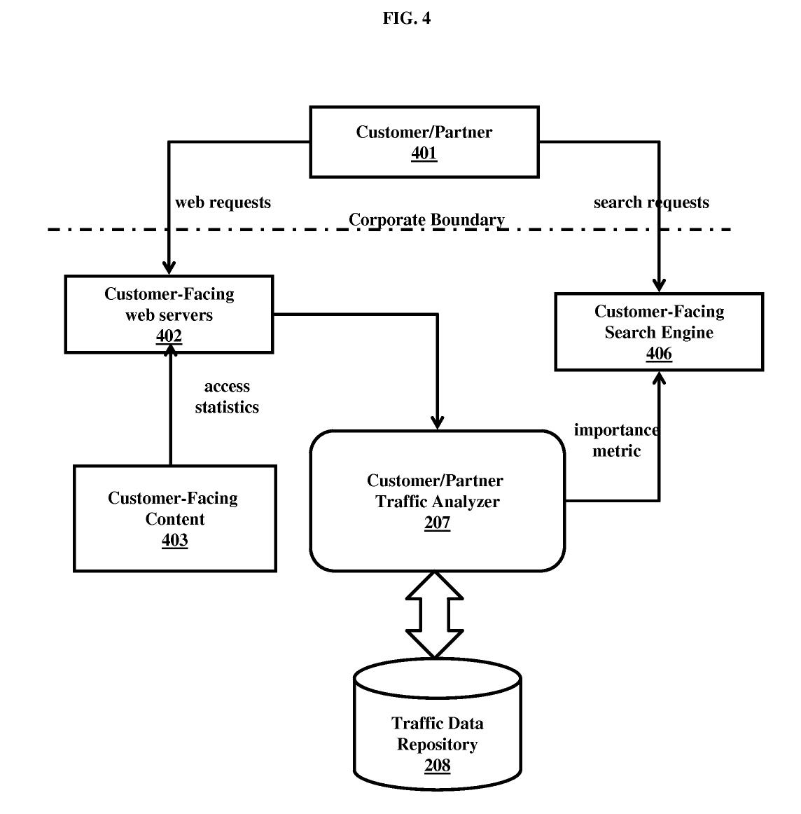

FIG. 4 depicts traffic analyzer being used to improve customer-facing search, according to embodiments as disclosed herein. It discloses customer/partner 401 is connected to customer-facing web server 402 and search engine 406 to request for web and perform search respectively. Customer 401 access corporate content via corporate web servers 402. Access statistics are collected and submitted to a customer-facing Traffic Analyzer 207. The traffic analyzer 207 is connected to data traffic repository 208 where it stores all the data. The customer-facing web server 402 is connected to a customer-facing content 403 to extract access statistics. The customer-facing Traffic Analyzer 207 provides importance metric to corporate search engine 406 serving external search requests. If a searcher's personal information is available (for example, partner provided), it could be incorporated using the same personalization methodology which is used for internal employees.

The proposed technique could be useful in the context of different use cases within an enterprise. Some of them are mentioned hereinafter. Let Bob, John and Melissa work for ACE enterprise that markets fire-safety equipment.

### Case 1: Page Ranking Based on an Employee's Web Access History

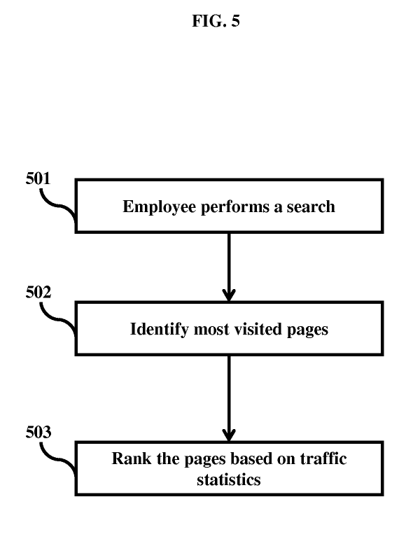

FIG. 5 is a flow diagram depicting the process of page ranking based on an employee's web access history, according to embodiments as disclosed herein. An employee performs a search (501) through a browser. Traffic analyzer identifies (502) most visited web pages. These web pages are ranked (503) based on traffic statistics. Let Bob performs a search for “candles”, the search engine retrieves 100 pages that mention “candles”. An automatic procedure analyzes access traffic to all 100 pages. This procedure uncovers that Bob visited “Church Lighting” page 10 times last week. The other 99 pages were visited only sparingly. Search engine ranks “Church Lighting” page highest in the list based on the traffic statistics. As the search engine extracts 100 web pages when a user performs a search for candles, the search engine identifies user credentials, employee number IP, cookies, etc and submits these information along with 100 hits to the Traffic analyzer. The traffic analyzer computes the importance metric for each search hit with respect to a searcher. The search engine then incorporates provided importance metric in its internal ranking algorithm. For example, the ranking algorithm may simply add a page “importance” metric to other relevancy scores used by that engine's ranking procedure. Search hits are re-ranked and presented back to the user. If user context (his resent browsing history) is available, the context sensitive importance measure could be used to further improve page ranking. The various actions in method 500 may be performed in the order presented, in a different order or simultaneously. Further, in some embodiments, some actions listed in FIG. 5 may be omitted.

Case 2—Page Ranking Based on Web Access History of Employees with Similar Job Profile

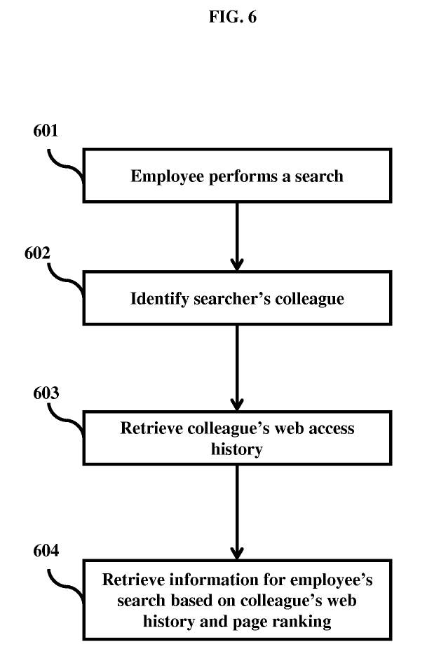

FIG. 6 is a flow diagram depicting the process of page ranking based on web access history of employees with similar job profile, according to embodiments as disclosed herein. An employee performs a search (601) through a browser. Traffic analyzer identifies (602) employee's colleague with similar job profile and retrieves (603) his/her web access history. The employees search retrieve (604) information based on colleague's web access history and corresponding page ranking. Let John recently join the enterprise and he performs a searches for “hose”, but since he recently joined the company his web access history is not informative. However, John and Bob both belong to same department, then it is likely that John may be interested in the same “hose” stories that Bob visited. Further, traffic analysis automatically assigns higher ranks to the pages frequently visited by Bob and provides this ranking to the search engine, which in turn shows Bob's “hose” pages to John. The various actions in method 600 may be performed in the order presented, in a different order or simultaneously. Further, in some embodiments, some actions listed in FIG. 6 may be omitted.

### Case 3—Age Base Ranking

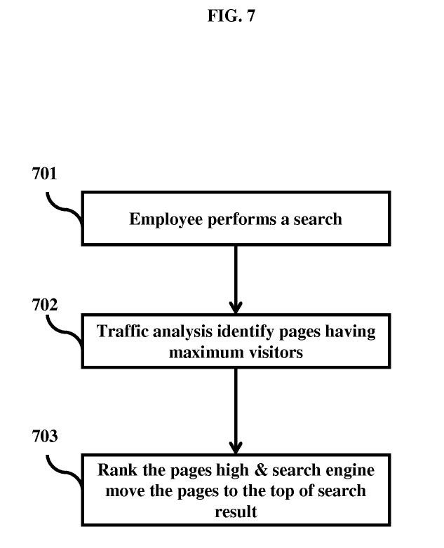

FIG. 7 is a flow diagram depicting the process of page ranking based on age of information, according to embodiments as disclosed herein. An employee performs a search (701) through a browser. Traffic analyzer identifies (702) web pages having high volume of visitors. Traffic analyzer ranks (703) these pages high and search engine places these pages to the top of search result. Let HR department of enterprise publishes a document related to employees ESPP participation. The corporate search engine is overloaded with “ESPP plan” queries from concerned employees. The link to the plan papers appears only on the forth page of the search results. Since most searchers do not look that far, employees are confused and submit IT tickets. In this paradigm, traffic analysis quickly discovers that high volumes of employees are visiting the corresponding ESPP web page(s). This results in a rapidly growing rank for these pages, and the search engine moves ESPP publication(s) to the top of search results. The various actions in method 700 may be performed in the order presented, in a different order or simultaneously. Further, in some embodiments, some actions listed in FIG. 7 may be omitted.

### Case 4—Home Page Identification Based on Overall Web Access Statistics Through the Entire Enterprise.

Further, FIG. 7 could depict the process of home page identification based on overall web access statistics through the entire enterprise. An employee performs a search (701) through a browser. Traffic analyzer identifies (702) web pages having high volume of visitors. Traffic analyzer ranks (703) these pages high and search engine places these pages to the top of search result. ACE Corporation provides web access to employee's 401K service. The service web front_is located on the partner's network (http://ACE401K.partner.com), which the corporate search does not index. When Bob is searching for “401K”, he finds ten of pages on 401K procedures, limitations, tax consequences and corporate polices, but not the home page of the service he actually needs. Traffic Analysis suggests that employees frequently search for “410K” and visit external site “http://ACE401K.partner.com” and not the pages found by the search engine for “410K”, even though 410K is a part of the URL. Based on this analysis, the search engine will present http://ACE401K.partner.com as the first hit on the search result page, thus giving employees the immediate access to the service they are looking for.

### Case 5—Index Trimming

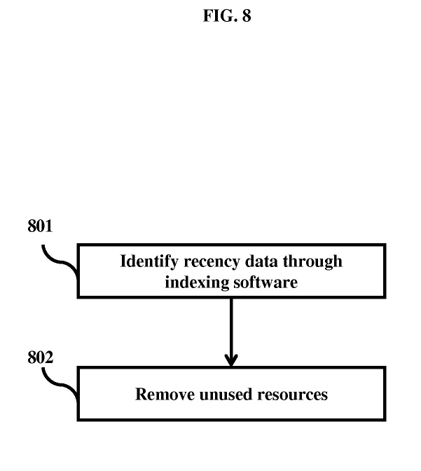

FIG. 8 is a flow diagram depicting the process of index trimming, according to embodiments as disclosed herein. Resources are checked (801) to identify recentness of data with the help of indexing software. Recent data are identified (802) which help in removal of unused (or never used) resource. After aggressive indexing the ACE corporate search index may grow to 1 terabyte and can be expensive to maintain. 90% of the indexed data is outdated, but it's not possible to determine which data can be discarded. Traffic Analysis provides access recentness data to indexing software which enables removal of unused (or never used) resources. This radically reduces index size, improves search speed performance and frees important computing resources for the information that is in high demand. The non-importance of a resource is just as useful as its importance. If a particular resource has never been accessed (or has never been accessed for the past year), there is no reason to keep it in the search index. The infrequently visited resources may be moved to slower, less expensive storage for archival or forensic purposes. This may enable a search engine to reduce its index size, improve search speed performance and free important computing resources for the information that is in high demand. The application process could comprise of a search engine which periodically sends query to the Traffic Analyzer on behalf of every page in the index. The Traffic Analyzer provides an overall importance for every page in the query and the search engine removes the low importance pages from the index. The various actions in method 800 may be performed in the order presented, in a different order or simultaneously. Further, in some embodiments, some actions listed in FIG. 8 may be omitted.

### Case 6—Selective Indexing Based on Employees Web Access History

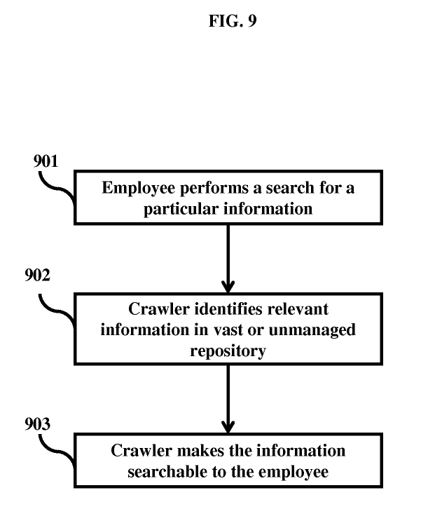

FIG. 9 is a flow diagram depicting the process of selective indexing based on employee's web access history, according to embodiments as disclosed herein. An employee performs a search (901) for a particular report/information through a browser. Crawler in network identifies and selects (902) the report/information from vast or unmanaged repository. Further, the crawler makes (903) the report/information searchable to the employee at corporate level. For example, say Melissa is a world renowned expert on “fire extinguishers”. She puts her reports into a departmental wiki-repository. As this repository may be polluted with outdated, unused and department specific content, the corporate crawler never submits repository pages to the corporate search index, and therefore, Melissa's research cannot be found via the corporate search. Traffic Analyzer analyzes that Melissa's reports are not in the corporate search index while Bob and John routinely download Melissa's reports. Further, corporate crawler selects only Melissa's reports from otherwise polluted wiki-repository and makes them searchable at the corporate level. The enterprise information space has a multitude of information silos—document collections maintained by local groups (e.g. departmental wikis). The majority of the data in these silos is rarely updated, often forgotten, and has no value even to the few employees that had created them. However, some of these pages have critical value to many employees within and outside the department owning the wild. It is virtually impossible for a search engine to tell which pages are important and which are not, hence the corporate search engines ignores the whole silo, thus missing critical information. The importance metric could be used to solve the mentioned problem. The search engine crawler (the information discovery agent) finds an information silo and the crawler queries the Traffic Analyzer on behalf of every resource in the silo. The Traffic Analyzer provides the overall importance metric to queried resources. Further, the crawler submits pages that have a high importance score to the corporate search repository. The various actions in method 900 may be performed in the order presented, in a different order or simultaneously. Further, in some embodiments, some actions listed in FIG. 9 may be omitted.

### Case 7—Cross-Linking Data Between Disjoint Corporate Tools

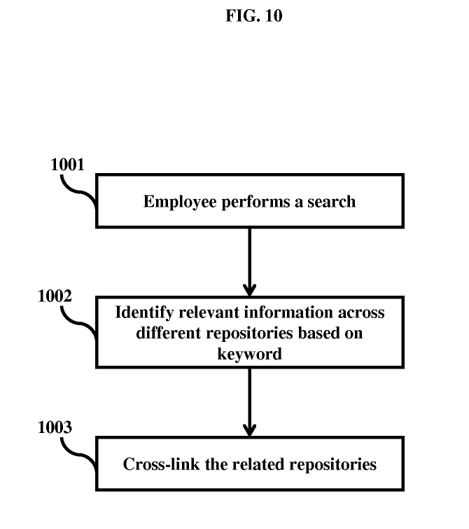

FIG. 10 is a flow diagram depicting the process of cross-linking data between disjoint corporate tools, according to embodiments as disclosed herein. An employee performs a search (1001) for a particular information through a browser. Relevant information is identified (1002) across different repositories based on keywords. Further, related repositories comprising relevant information are cross-linked (1003). Let ACE corporation workforce uses numerous intranet tools and search repositories to complete a business task at hand For example, Bob—an engineer, has to access multiple web tools to root cause and fix a bug. Bob's bug fixing task turns into a complicated process of getting around an interwoven web of intranet tools. Firstly, Bob goes to the corporate bug database and finds a bug description using a Bug Identifier. The bug description contains a Customer Issue Identifier, so Bob has to go to a customer-found-issues database and, using a Customer Issue Identifier, loads the corresponding customer complaint. The customer complaints that the feature of a particular fire hose does not function as the marketing brochure advertised. Therefore, Bob goes to a corporate portal and spends some time looking for the “fire-hose” documentation released to a customer. Further, Bob goes to product literature wiki and extracts a corresponding Product Requirements Document (PRD) for the offending feature. From PRD, Bob goes back to the corporate portal and identifies the marketing material to see what was actually advertised to a customer. After few days of struggle in collecting all the information, Bob makes a determination that the marketing literature contradicts Product Requirements and resolves the bug “as designed”. By working through this complicated process, Bob makes explicit choices of which pages from which tools are related to each other and the business process he follows: the URLs of the pages Bob visited, and the search queries Bob issued contain keywords that identify each page in each repository. John and Melissa also go through similar processes daily, hence, traffic statistics available for analysis is abundant and identifies which repositories are related and should be cross-linked. The keyword pattern, query URL and name entities like product features, release names, etc are identified for data items in each repository. For example, Traffic Analysis of the ACE bug fixing statistics reveals that these tools are used and searched together.

Next time when Bob comes to the Bug Database and loads a bug description, the application finds important keyword in this description searches all other relevant repositories for corresponding items and presents all related data to Bob. Hence, Bob can make the decision in quick time.

Analysis of the collaborative use of web resources uncovers how disjoint, corporate tools are actually being used by the work force. This analysis may reveal how intranet users actually hunt for related information pieces in each tool and/or repository. Once the pattern of access to related data in various repositories is discovered, the system automatically cross-links the related data from each repository and presents the complete information to the user needed to for the business task. One methodology to implement such discovery mechanism is to look for keyword patterns in URLs and text of the pages that belong to tools being used together. For example, the discovery process may comprise of identifying corporate tools like databases, repositories, and applications having well defined URLs. All the pages prefixed with the tool URL are said to belong to that tool, or that a participial tool forms a collection of pages. Further, each tool is a collection of pages; the predictive measure could be used between page collections to identify tools that employees often use together. Statistical analysis is performed on pages and URLs for every pair of related tools that were used by the same user, at the same time. These page ought to be related since, there was a real person using them together at one time. “Follow-a-user-choices” statistical process will discover keywords connecting pages from different repositories. Different strategies could be deployed for keywords discovery. Looking for non-dictionary words used in URLs will pick up patterns covering various identifiers used in databases or bug repositories. Such identifiers purposely have explicit and memorialize-able structures, like 4 leading letters followed by 7 digits. The technique may pick up version numbers and code names. Further, analyzing queries issued by users to find necessary pages in relevant tools and analyzing related pairs of pages from disjoint tools and computing set of keywords used in both pages, etc.

An art practitioner will employ multiple techniques to develop a set of keywords identification algorithms, or rules or procedures by which pages from different tools could be linked. The system applies multiple techniques to identify a set of keywords to every page in a one repository and link that page to the relevant pages in the other repository. For example, suppose if a bug description is linked with a customer-defect database. The discovery process identifies that a customer-defect database pages are referenced by 7 digits ID. Further, when a user loads a description of a bug, a browser plug-in (or a server) looks for 7 digits numbers in the text of the bug, and if found checks the customer-defect database for a defect with such ID. If the ID found is present in the customer-defect database, a browser plug-in automatically generates a link to that customer-defect and presents it to the user.

Another approach would be to find 7 digit IDs in bug descriptions by a batch process offline. The various actions in method 1000 may be performed in the order presented, in a different order or simultaneously. Further, in some embodiments, some actions listed in FIG. 10 may be omitted.

As described above, the Traffic Analyzer finds resources from disjoint tools that are used by the same user at the same time. These resources are related to each other since there is a user who needs both of the resources together at the same time. Then Traffic Analyzer applies appropriate machine learning techniques to extract from related resources contextual clues (for example, keywords) used by users to find related information across disjoint repositories. The Traffic Analyzer performs actual linkage of such resources. This can be done off-line or in real time.

In real-time mode, the content of a resource is loaded and it is presented to the Traffic Analyzer when a user loads the page. The Traffic Analyzer profiles the page in order to find the contextual clues (like keywords) by which related pages from other repositories may be found. If such clues are found in the text of the current resource, then for every such clue, the corresponding repository may be searched. Further, if there is a page available in the other repository that matches one of the clues found in the downloaded resources, it's presented to a user.

In off-line mode, all pages in a single repository are profiled with respect to contextual clues and all corresponding pages from other repositories are found. The process populates a database with information of how pages from various repositories are linked together. When a user loads a particular page, the database is accessed and the linkage corresponding to a given page is retrieved and presented to a user.

### Case 8—Context Sensitive Search

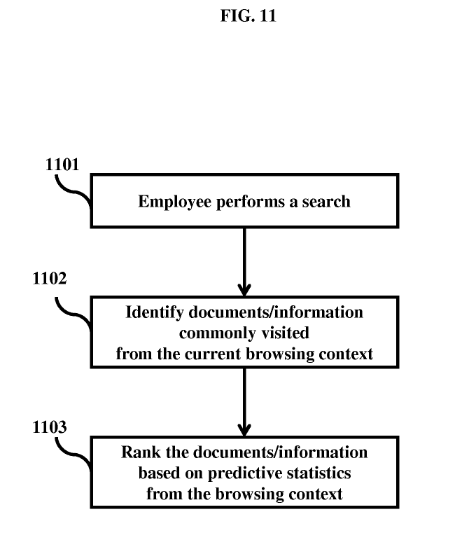

FIG. 11 is a flow diagram depicting the process of context sensitive search, according to embodiments as disclosed herein. An employee performs a search (1101) for particular information through a browser. Traffic analyzer identifies (1102) pages commonly visited from the employee browsing context (employee's recent browsing history). Further, the search result pages are ranked (1103) based on statistics predicting which pages an employee may need given his/her browsing context. Let Bob perform bug fixing task. Bob searches the corporate site for customer documentation and PRD related to “fire hose”. However, the search results are heavily polluted by “fire hose” sales reports, “fire hose” safety conference publications, a recent CEO speech on the future of the “fire hose: industry, etc. Bob wastes hours looking for the “fire hose” documentation and/or PRD pages due to noisy search results. The Traffic Analysis discovers that Bob and his colleagues mostly visit documentation or PRD pages when they work with the corporate bug database. Therefore, when it's known that Bob has recently visited the bug database tool, the corporate search should highly rank pages form documentation and PRD sections of the corporate content and down-rank the others.

Employee's specific task performed requires certain information for successful completion of task. For example, Melissa—an ACE development manager, may search for a “fire hose” while performing two entirely different tasks. In one context, she may be working with a corporate Bug Database, in which she is looking for “fire hose” documentation. However, if she works with marketing on the future generation of the product, she needs the “fire hose” competitive analysis and marketing content. Indeed, the search engine is not able to distinguish context(s) of Melissa's searches. This information may come from the analysis of how enterprise users collectively interacted with the corporate intranet.

Let a traffic statistics reveals a 50% chance of page “B” being visited if page “A” was visited. Therefore, page “B” commands a higher importance if a user is known to access “A” recently. Therefore, a user's recent browsing history defines the context of his/her immediate work task, and thus, influences which information resources he/she needs most to perform such task.

It is, therefore, important to quantify the likelihood that a visit to page “A” implies (or predicts) a visit to page “B”. Numerous methods to measure can be implemented to develop a simple metric reflecting such likelihood. When two pages “A” and “B” are given, the measure P_{ab} of how much A visit “predicts” B visit can be computed by identifying closest (time wise) A visit preceding for every B visit. Further, identifying the time elapsed between this pair of visits—call it the age of a pair (AGE_{ab}). Add up all “B-after-A” visit pairs normalized by their corresponding ages.

P_{ab}=Σ_{b=1}^{N}1/|AGE_{ub}|,

here N is the total number of “B-after-A” visit pairs.

This measure may be extended by taking into account a user current visit of page A, and how much this specific user and/or his colleagues have has accessed B after they accessed A. Such, personalized metric P^{u}_{ab} takes into account relationship between users making a transition from “A” to “B”.

P_{ab}^{u}=Σ_{b=1}^{N}Rᵤ/|AGE_{ab}|,

here Rᵤ denotes the relationship strength between user and an actual page visitor.

This measure may be extensible to a collection of pages “implying” a visit to a page “B”: User's recent browsing history is available through a browser history, or http access logs. A user context can be defined as a collection of pages in his recent browsing history (call this collection H), therefore the measure of how much the user context H implies a visit to B can be given by:

P_{hb}^{u}=Σ_{hεH}P_{hb}^{u}

here the sum is taken over all pages in H

It is often important to know how a user context implies not only a visit to an individual page, but rather to any page in a particular collection of pages. For example, a visit to a documentation page, or HR publication, or pages comprising a vocation planning tool. Let's denote a target collection as T, then our predictive measure is trivially expressed as:

Pₕₜ^{u}=Σ_{tεT}Σ_{hεH}Pₕₜ^{u}

Where the t denotes pages in the target collection T, and h denotes pages in the user's browsing history H.

Such predictive measure can be used in the computation of a page importance to a particular user with respect which context the user is in. Given a page A, a user u, and user's context H, the context sensitive importance measure could be expressed as:

Iᵤₕ=Iᵤ+Σ_{hεH}Pₕₐ

The search engine may use the above measure to further improve search result ranking, if the browsing history is known. Further, the measure could be applied to recommend an employee certain pages or certain collections of pages which are being routinely visited by the user or his colleagues while performing the task represented by the user's context. The various actions in method 1100 may be performed in the order presented, in a different order or simultaneously. Further, in some embodiments, some actions listed in FIG. 11 may be omitted.

### Use Case 9—Personalized Intranet Navigation

A user's most appreciated information accessed by a user and/or his immediate colleagues is repeated and recent. Quantification of such information importance is useful to intranet navigation in as much as it's for intranet search. Traffic Analysis enables significant improvements in personalizing employees' navigation through the corporate web. Corporate intranet consists of thousands of tools of which an employee uses only a tiny fraction in his daily tasks: navigating workers directly to the tools they need (and when they need them) radically improves intranet fluency and efficiency.

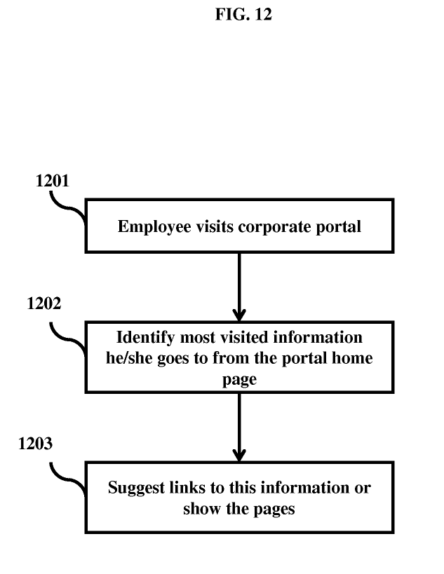

FIG. 12 is a flow diagram depicting the process of personalized intranet navigation, according to embodiments as disclosed herein. An employee visits to a corporate portal home page (1201). Traffic analyzer identifies (1202) which pages an employee goes to from the portal home most often and most recently. Further, links to commonly visited documents are suggested (1203). Consider John to be a new employee. He goes to the corporate portal to update his vocation time and manage his stock option. He rarely uses other tools exposed at the portal front page. Nonetheless, he has to click five times before he gets to the vocation time tracker or the stock option plan. Since John is new, he may spend long time figuring out location of the tools, and may get annoyed with the five clicks needed to get through the corporate web to the only tools he ever used.

Traffic Analysis quickly discovers that John and his immediate collages are likely to go to vocation tracker from the portal front page. Therefore, next time when John visits the portal, he is suggested direct links to vocation and stock option tools.

Recent and frequent access to the information indicates its value to a user regardless of whether he is looking for or navigating to such information. Quantification of access patterns provides an explicit importance measure of a particular resource to a particular user. This measure enables radical improvements in how employees navigate through the intranet as well as how they search it. Traffic Analysis enables intranet personalization for either task Implementation of personalized intranet navigation can be done in a variety of ways: for example, a corporate portal may consult Traffic Analyzer to find out which corporate web tools need to be shown to a particular employee, or a web browser plug-in may suggest links to certain, popular intranet pages. For example, the system may notice that engineers mostly go to the vocation planning tool from the corporate portal and simply suggest a direct link to this tool when an engineer access the corporate portal.

A simple process of finding pages to recommend to a particular employee could be by finding the page(s) with the high importance to that employee and his/her current browsing context, and recommending 3 top pages from that list. Another process could be to identify corporate tools, compute the average user's importance of page(s) under web tool(s) collections and recommend the important tools (important collection of pages grouped together) rather than a single page. An art practitioner will be able to find numerous ways to use Traffic Analyzer to improve navigation experience with the enterprise. The various actions in method 1200 may be performed in the order presented, in a different order or simultaneously. Further, in some embodiments, some actions listed in FIG. 12 may be omitted.

For dynamic, context sensitive intranet navigation, the user current context in the form of the immediate browsing history is delivered to a Traffic Analyzer by a corporate portal and/or a borrower plug-in. A list of recommended URLs to pages or tools customary used in user's context is delivered back to an agent communicating to user which could be a browser plug-in, or corporate portal software handling current user session, or a special software that a user may install on his system, or even a special web server where a user may go to ask for navigational recommendations.

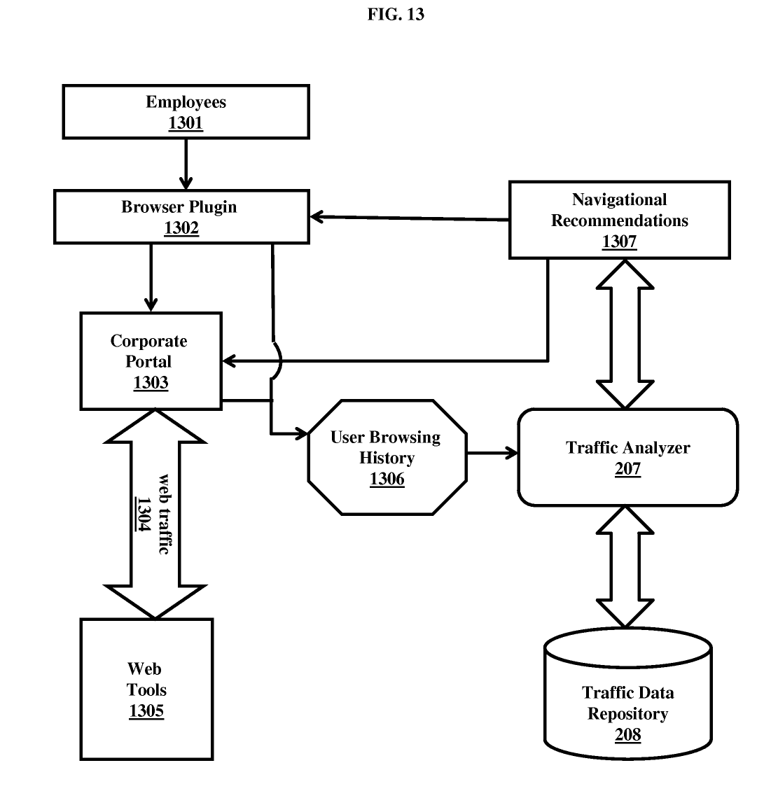

FIG. 13 depicts traffic analyzer in Smart Intranet navigation, according to embodiments as disclosed herein. Employees 201 browse the net through a browser plug-in 1302. The browser plug-in 1302 interacts with corporate portal 1303 from which it manages web traffic 1304 across web tools 1305. Further, browser plug-in 1302 connects to user browsing history 1306 where users browsing logs are extracted from browser plug-in 1302 and stored in browsing history 1306. User browsing history is connected to the traffic analyzer 207. The user employee communicates to the Traffic Analyzer 207 path through the intranet. The traffic analyzer 207 is connected to traffic data repository 208 where all the information about traffic and browsing is stored. The Traffic Analyzer compiles a list of URLs pointing to either important information resources, or home pages of the tool(s) necessary to perform the task suggested by the user context. A navigational recommendation 1307 is connected to traffic analyzer 207 and it recommends relevant URLs to the employee through a browser plug-in 1302.

Alternatively, a corporate portal may dynamically change the navigational page to immediately present the employee with URLs of tools/resources he or she will require.

A similar embodiment permits search improvement for an Internet site. If an Internet site provides both the content and the search service (directly or through an outsourced partner), the search quality may be improved by employing Traffic Analyzer operating over the access statistics collected from the Internet users.

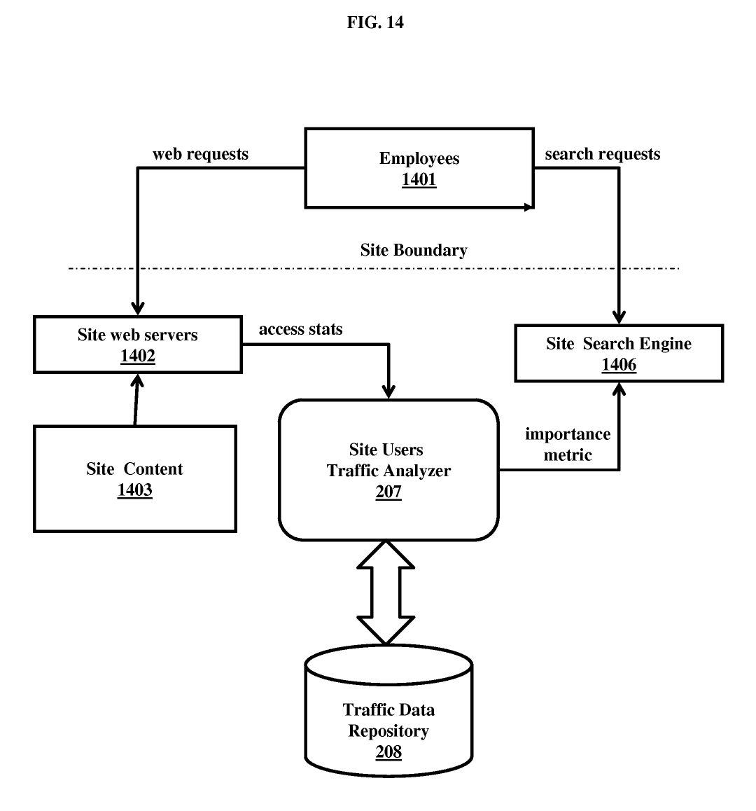

FIG. 14 depicts traffic analyzer being used to improve Internet site local search, according to embodiments as disclosed herein. Employees 201 access site content via site web servers 1402. Site web server 1402 is retrieves content from site content 1403. Access statistics are collected from site web servers 1402 and submitted to the site Traffic Analyzer 207. The traffic analyzer 207 is connected to traffic data repository 208 which stores information regarding access statistics. The Traffic Analyzer 207 provides importance metric to the site search engine 1406 serving Internet search requests. If the employee personal information (for example, gender or age) is available, it could be incorporated using personalization methodology as described earlier in the document.

The Internet search problem space is different from that of an enterprise. It is difficult to exhaustively monitor Internet user's web activity. Internet user's personal information could be very limited or not available and it may be hard to identify user's identity. The sheer volume of Internet web data and the search traffic is such that traditional methods of generating page importance (counting cross links between pages, for example) often provide adequate page ranking without deploying sophisticated personalization technique.

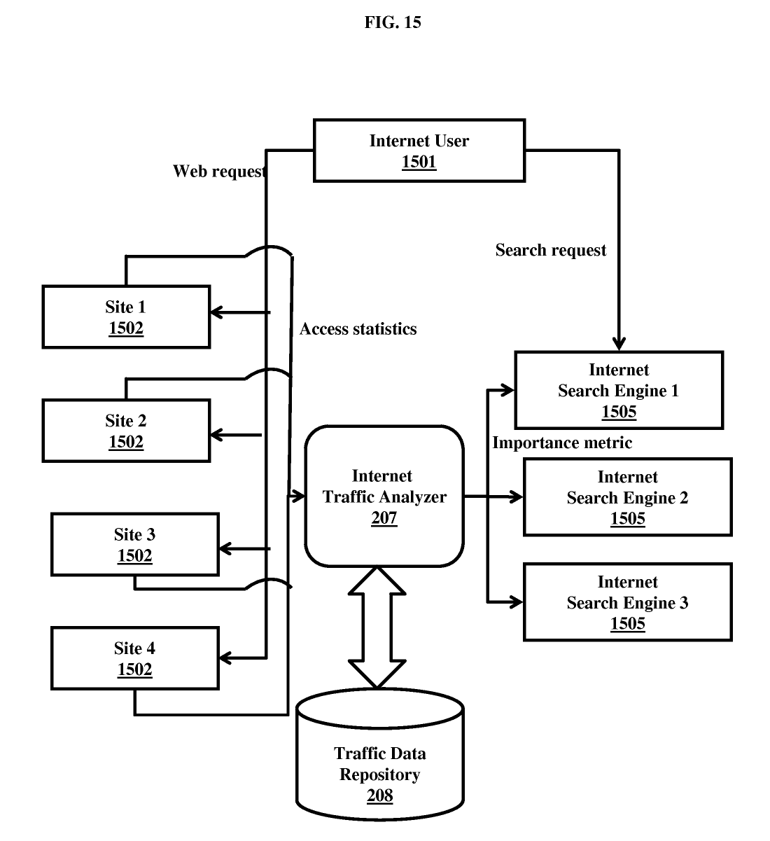

The methodology applies to the Internet search. Resources visited most are more important than those that are least visited. Information about user's category and his/her browsing activity can be provided by reliable methods and this information can be aggregated using Traffic Analysis as depicted on FIG. 15.

FIG. 15 depicts traffic analyzer being used for cross-site Internet searching, according to embodiments as disclosed herein. Internet users 1501 access multiple sites 1502. These sites 1502 accumulate resource access on behalf of a particular Internet user 1501. Further, these sites set the “cookie” in the users' browser (for example, it could be “Traffic_Analyzer” cookie, which will allow cross-site identification of a user who accessed each site content. These sites 1502 submit access statistics (comprising of a user description, the cookie set, the pages accessed, the searches made locally at the site, etc.) to the Internet Traffic Analyzer 207. For example, the participating site 1502 may submit web access logs information to the Internet Traffic Analyzer 207. The Internet Traffic Analyzer 207 tracks down which user accessed which page at, which site and when and computes importance metric for each site resource. The Internet Traffic Analyzer 207 provides the importance metric to a requesting Internet search engine(s). Further, the Internet traffic analyzer 207 is connected to traffic data repository 208 which stores information like access statistics and importance metric. Furthermore, if users' personal data like geographical location, gender, national group, etc. are available, it is used by the Internet Traffic Analyzer 207 to compute personalized importance metric for a given resource (Internet page) with respect to a particular searcher. The Internet Traffic Analyzer 207 could assist individual sites searches as well as the cross-site Internet searches. Since the Internet sites commonly collect web access logs, it may be possible to provide “importance” metric by collecting and analyzing these logs.

An art practitioner will be able to advice numerous other measures to reflect the dependency of a user's browsing history and his or her information needs. Among such techniques are the hidden-markov chains, conditional-random-fields, maximum like hood estimations, neural nets, fuzzy maps, and effectively, the whole arsenal of machine learning techniques. The scope of this application is not to disclose yet another machine learning technique, but to describe how any such techniques could be applied to extract critical relevancy information from the enterprise intranet traffic, and how the measure of such relevancy can be used to radically improve information flow, especially within the enterprise boundaries.

Traffic Analysis can identify external web resources important to the corporate workers (provided the privacy issues are not violated), gauge effectiveness/popularity of partner sites, discover information silos (for example, wiki repositories) select important content in them, and cross-link it together to streamline the process of information search across enterprise. A skillful practitioner will recognize the spectra of applications much wider than described in the above use cases. The great utility of the Traffic Analysis comes from its ability to quantify the actual importance of a web resource by direct aggregation of how often it's being accessed, when and by whom. Another utility comes from collecting and analyzing the collaborative use of intranet tools within an enterprise, which enables cross-linking between otherwise isolated tools, and further improves corporate search and navigation by taking into account the current task an employee performs. This technique resolves many hard problems of the enterprise search, and greatly improves already existing solutions. Furthermore, the same techniques are applicable for improvement of customer-facing search services as well as Internet search services.

The method is implemented in a preferred embodiment through or together with a software program written or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for enhancing access to information in an enterprise, said method comprising
analyzing enterprise wide user data available within the enterprise to improve personalized resource ranking.

2. The method as in claim 1, wherein said data comprises at least one of user data traffic patterns, user identity, credentials, user web session, URLs of the accessed web resources, content of requested pages, date/time of the requests being issued, user personal data, corporate communications data, meetings co-participation, and corporate groups co-membership.

3. The method as in claim 1, wherein said method further assigning importance metric to rank said resources.

4. The method as in claim 3, wherein said method assigning said importance metric, where said importance metric incorporates at least one of
frequency of visits by said user;
recency of visits by said user;
session contexts of said user; and
strength of relationships between said user.

5. The method as in claim 1, wherein said resource is an entity available on the intranet and accessible by said user.

6. The method in claim 5, wherein said entity could be one of: web page, application, document, tool, repository, database record and link to said resources.

7. The method as in claim 1, wherein said resource ranking is used in cross linking data between disjoint repositories.

8. The method as in claim 1, wherein said resource ranking is used in ranking search results in an enterprise.

9. The method as in claim 1, wherein said resource ranking is used in context based navigation.

10. A system for enhancing access to information in an enterprise, said system comprising a data traffic analyzer that is configured for
analyzing enterprise wide user data available within the enterprise to improve personalized resource ranking.

11. The system as in claim 10, wherein said system collects user data comprising at least one of user data traffic patterns, user identity, credentials, user web session, URLs of the accessed web resources, content of requested pages, date/time of the requests being issued, user personal data, corporate communications data, meetings co-participation, and corporate groups co-membership.

12. The system as in claim 10, wherein said system further assigning importance metric to rank said resources.

13. The system as in claim 12, wherein said system assigning said importance metric, where said importance metric is at least one of
frequency of visits by said user;
recency of visits by said user;
session contexts of said user; and
strength of relationships between said user.

14. The system as in claim 10, wherein said resource is one of web page, application, document, tool, repository, database record and link to said resources.

15. The system as in claim 10, wherein said resource ranking is used in cross linking data between disjoint repositories.

16. The system as in claim 10, wherein said resource ranking is used in ranking search results in an enterprise.

17. The system as in claim 10, wherein said resource ranking is used in context based navigation.
